(19) United States
(12) Patent Application Publication
(10) Pub. No.: US 2003/0132844 A1
(43) Pub. Date: Jul. 17, 2003

(54) Golf bag loss prevention system

(76) Inventor: Daniel Walker, Calgary (CA)

Correspondence Address: WILLIAM H. WRIGHT, HENDERSON & STURM LLP, SUITE 1020, 1301 PENNSYLVANIA AVE., N.W., WASHINGTON, DC, 20004, US

(21) Appl. No.: 10/050,325

(22) Filed: Jan. 16, 2002

(51) Int. Cl. G08B 13/14

(52) U.S. Cl. 340/568.6; 340/539.23

(57) ABSTRACT

A golf bag loss prevention system (10) including a control unit (11) attached to a golf bag (100) and an alarm unit (12) worn by a golfer (200) wherein the alarm unit (12) includes a micro-controller member 30 having a piezo film sensor (35) capable of generating a voltage signal proportional to the amount of movement imparted to the golf bag (100) wherein the micro-controller member (30) converts the voltage signal into a frequency signal that is transmitted to the control unit (11) having a variable frequency sensitivity switch (22) operatively associated with at least one alarm (25/26) that is actuated when the control unit (11) receives a frequency signal from the alarm unit (12) that corresponds to the setting of the frequency sensitivity switch (22).

### BACKGROUND OF THE INVENTION

### CROSS REFERENCE TO RELATED APPLICATIONS

Not applicable.

1. Field of the Invention

The present invention relates to the field of golf accessories in general and in particular to a programmable golf bag loss prevention system having multiple sensitivity settings.

2. Description of Related Art

As can be seen by reference to the following U.S. Pat. Nos. 5,877,686; 5,973,596; 5,610,585; 5,870,023, and 5,783,996, the prior art is replete with myriad and diverse golf bag security systems.

While all of the aforementioned prior art constructions are more than adequate for the basic purpose and function for which they have been specifically designed, they are uniformly deficient with respect to their failure to provide a simple, efficient, and practical programmable golf bag security system to prevent the loss of a golf bag and its contents.

As most golfers are all too well aware over the last several years, there has been a dramatic increase in the number and frequency of thefts of golf equipment and in particular clubs and bags due in part both to the value of modern golf equipment as well as a recent increase in the popularity of the sport among poorer segments of the population that can ill afford such an expensive outlay for equipment.

As a consequence of the foregoing situation, there has existed a longstanding need among golfers, for a new and improved golf bag security system that can be programmed to alert the golfer once the golf bag passes beyond a selected one of a variety of distance parameters; and, the provision of such a security system is the stated objective of the present invention.

### BRIEF SUMMARY OF THE INVENTION

Briefly stated, the programmable golf bag loss prevention system that forms the basis of the present invention comprises in general a control unit and an alarm/flasher unit wherein the control unit is carried on the user's person and the alarm/flasher unit is carried on the user's golf bag to send a variable frequency signal to the control unit depending upon the degree of movement imparted to the golf bag.

As will be explained in greater detail further on in the specification, the control unit may be programmed for different sensitivity settings depending upon the amount of movement of the golf bag that the golfer wishes to trigger the alarm response.

Obviously there will be certain instances wherein the golfer could reasonably expect that there would be slight jostling of their golf bag such as at the bag drop-off area of a golf course whereas prolonged or more pronounced jostling would indicate that someone was making off with their golf bag. However, there will be other instances wherein even the slightest movement of their golf bag would indicate larcenous intent and the variable sensitivity setting of this loss prevention system is intended to address just those situations.

### BRIEF DESCRIPTION OF THE SEVERAL VIEWS OF THE DRAWINGS

These and other attributes of the invention will become more clear upon a thorough study of the following description of the best mode for carrying out the invention, particularly when reviewed in conjunction with the drawings, wherein:

FIG. 1 is an exploded perspective view of the golf bag loss prevention system that forms the basis of the present invention;

FIG. 2 is a schematic diagram of the alarm/flasher unit; and,

FIG. 3 is a schematic diagram of the control unit.

### DETAILED DESCRIPTION OF THE INVENTION

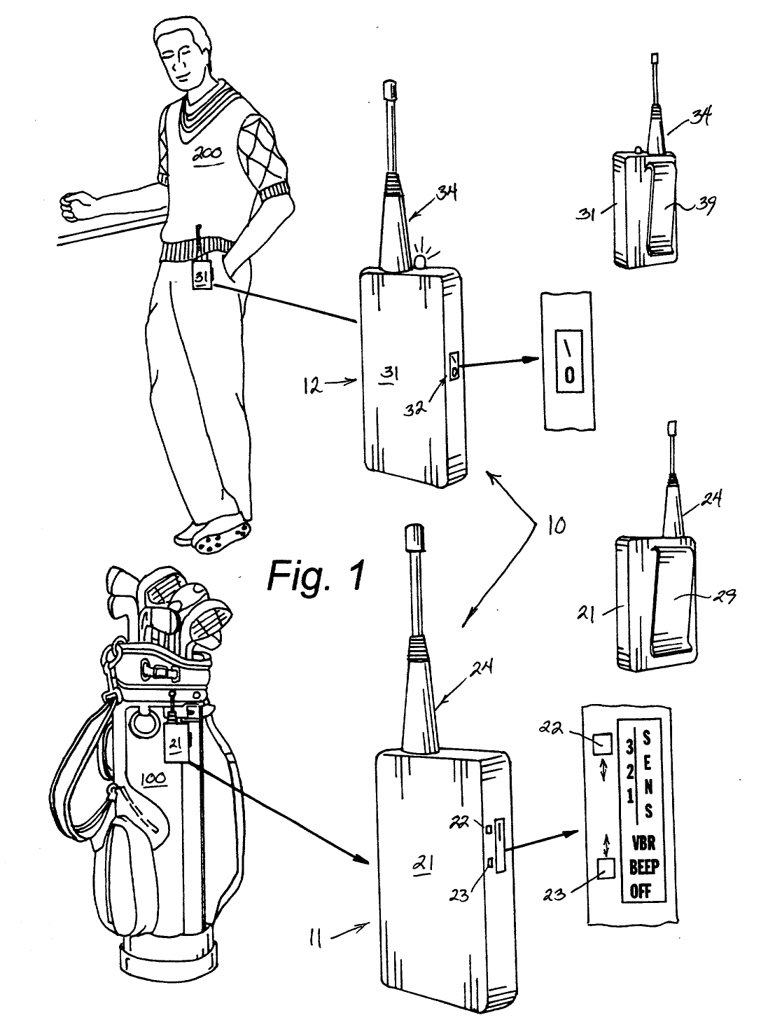

As can be seen by reference to the drawings, and in particular to FIG. 1, the golf bag loss prevention system that forms the basis of the present invention is designated generally by the reference number 10. The system 10 comprises in general a control unit 11 and an alarm/flasher unit 12 which is activated in response to movement of an unattended golf bag 100. These units will now be described in seriatim fashion.

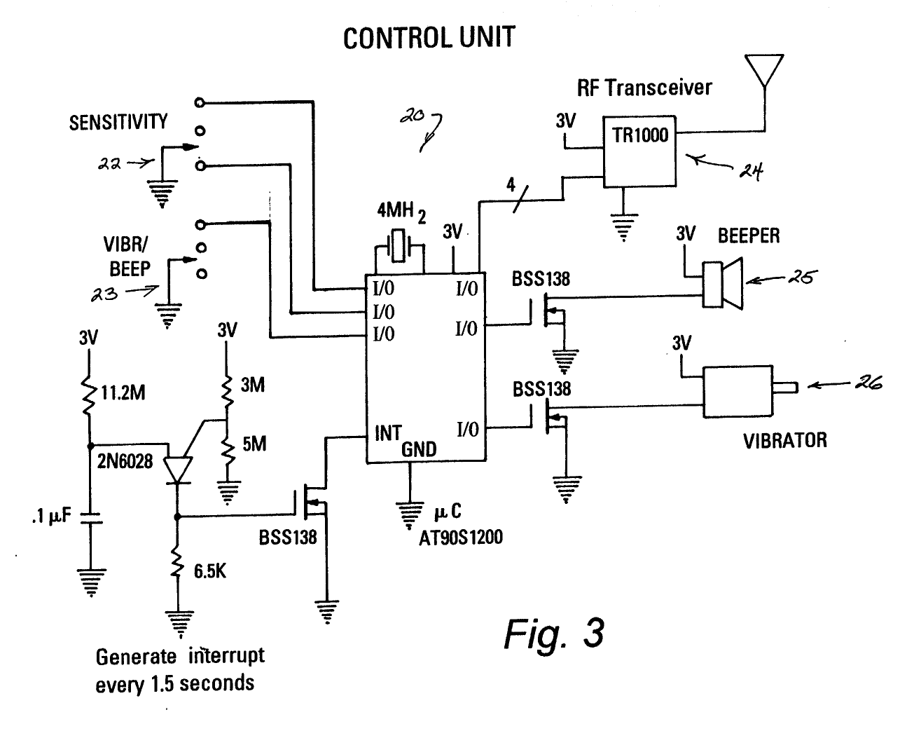

As can be seen by reference to FIGS. 1 and 3, the control unit 11 comprises a microprocessor control member 20 disposed within a housing unit 21 and having a pair of control switches 22 23 and an RF transreceiver 24; wherein the first control switch 22 governs the on/off operation of the control member 20 and whether or not an audible beeper 25 or silent vibrator 26 is actuated in response to the output from the alarm/flasher unit 12 as will be explained presently.

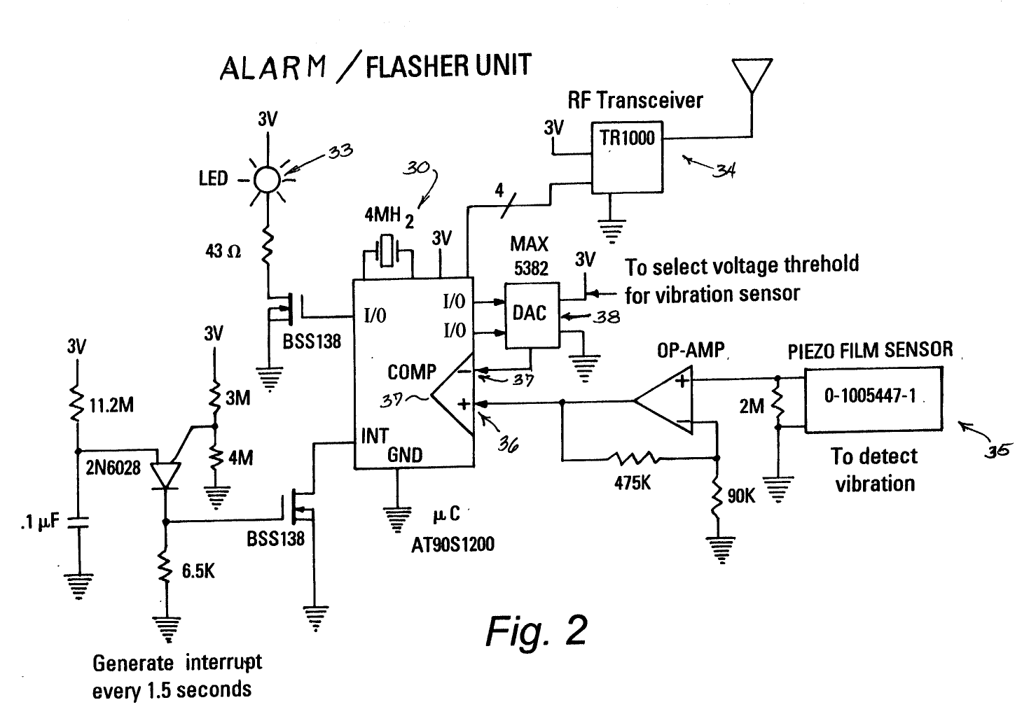

Turning now to FIGS. 1 and 2, it can be seen that the alarm flasher unit 12 comprises a microcontroller member 30 disposed within a housing 31 having an on-off control switch 32 and light emitting diode 33 and an RE transreceiver 34.

In addition the microcontroller member 30 includes a piezo film sensor 35 which generates a small voltage when it vibrates in proportion to the degree of vibration. This voltage is amplified and fed into one input 36 of a voltage comparator 36 on the micro-controller member 30 wherein the other input 37 of the comparator 36 is maintained at a steady voltage based on the output of a digital to analog converter 38 wherein the threshold voltage is established digitally by the micro-controller member 30, once it is determined which sensitivity setting has been established by the micro-processor control member 20, wherein the lower the threshold, the higher the sensitivity of the alarm/flasher unit 12 becomes.

The alarm/flasher unit 12 turns on in the receiver mode constantly looking for a signal at a selected one of the three fixed frequencies and the control unit 11 turns on and reads the setting on the sensitivity switch and then transmits every 1.5 seconds at one of the fixed threshold frequencies. After a short period of transmission, it switches to a scan mode constantly looking for a signal at the specifically selected threshold frequency.

Once the flasher/alarm unit receives the initializing signal, it begins to flash the LED 33 at a steady interval and immediately establishes a sensitivity mode based on the frequency of the received signal. Then when movement of the golf bag causes the piezo film sensor 35 to generate a voltage that exceeds the selected threshold frequency, an interrupt is generated by the voltage comparator 37 that causes the micro-controller member 30 to transmit an alarm signal.

The control unit 11 responds to this signal to read the setting on the microprocessor member 20 beep/vibrate switch 23 and then activating the corresponding alarm by either turning the sound transducer 25 on and off at an audible frequency or by applying power to the vibrator 26 to alert the golfer 200 of the unauthorized movement of their golf bag.

Returning once more to FIG. 1, it can be seen that the housing members 21 and 31 of the control unit 11 and the alarm unit 12 are provided with clip elements 29 and 39 for attaching the respective units 11 and 12 to the golf bag 100 and the golfers 200 in a well recognized fashion.

Although only an exemplary embodiment of the invention has been described in detail above, those skilled in the art will readily appreciate that many modifications are possible without materially departing from the novel teachings and advantages of this invention. Accordingly, all such modifications are intended to be included within the scope of this invention as defined in the following claims.

Having thereby described the subject matter of the present invention, it should be apparent that many substitutions, modifications, and variations of the invention are possible in light of the above teachings. It is therefore to be understood that the invention as taught and described herein is only to be limited to the extent of the breadth and scope of the appended claims.

I claim:

1. A golf bag loss prevention system comprising a control unit including a microprocessor member contained within a housing adapted to be connected to a golfer's person wherein the microprocessor member includes a first control switch for selecting one among a plurality of frequency settings and a second control switch operatively associated with at least one type of an alarm and further including a first RF transreceiver for sending and receiving a frequency signal corresponding to said selected frequency settings to activate said at least one type of an alarm,
an alarm/flasher unit including a micro-controller member contained within a housing adapted to be connected to a golf bag wherein the microcontroller member includes a puzo film sensor adapted to generate a variable voltage proportional to the amount of vibration imparted to thegolf bag and having first means for converting the variable voltage into a range of frequencies encompassing said plurality of frequency settings and a second RF transreceiver for sending and receiving a frequency signal corresponding to said selected frequency setting.

2. The system as in claim 1; wherein, said at least one type of an alarm includes a beeper.

3. The system as in claim 1; wherein, said at least one type of alarm includes a vibrator.

4. The system as in claim 1; wherein, said at least one type of alarm is chosen from among a beeper and a vibrator.

5. The system as in claim 1; wherein, said first means comprises a voltage comparator having two inputs wherein the first input is an amplified voltage signal from the piezo film senor and the second input is a steady voltage signal supplied by a digital to analog converter.

6. The system as in claim 5; wherein, the alarm flasher unit turns on int he receiver mode looking for a signal at a selected one of said plurality of frequency settings.

7. The system as in claim 6; wherein, the control unit turns on and reads the setting of the first control switch and transmits an initializing frequency signal to said micro-controller member.

8. The system as in claim 7; wherein, said initializing frequency signal is transmitted for short duration and on an intermittent basis.

9. The system as in claim 8; wherein, the transmission of said initializing frequency signal is followed by the microprocessor member switching to a scan mode seeking a transmission from the flasher/alarm member that corresponds to the selected frequency setting on the control unit to activate said at least one type of an alarm.

10. The system as in claim 9; wherein, said at least one type of an alarm includes a beeper.

11. The system as in claim 9; wherein, said at least one type of alarm includes a vibrator.

12. The system as in claim 9; wherein, said at least one type of alarm is chosen from among a beeper and a vibrator.
